(19) United States
(12) Patent Application Publication
(10) Pub. No.: US 2008/0141512 A1
(43) Pub. Date: Jun. 19, 2008

(54) Apparatus for removing or fitting a compression ring

(76) Inventor: Spencer James Freeman, Rochester (GB)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/999,751

(22) Filed: Dec. 7, 2007

(30) Foreign Application Priority Data
Dec. 8, 2006 (GB) 0624569.0

(51) Int. Cl. B23P 19/04

(52) U.S. Cl. 29/229

(57) ABSTRACT

Apparatus (2) for removing or fitting a compression ring (4), which apparatus (2) comprises a body (6), at least one externally threaded portion (8) which is on the body (6) and which is for receiving a compression ring nut (10), a bore (12) which is in the body (6) and which has a screw thread (14), a spindle (16) which has an external thread (18) and which is screwable backwards and forwards in the bore (12) in the body (6), at least one abutment means (20) for engaging an end (22) of a pipe (24) requiring the compression ring (4) to be removed, and a handle which in use is permanently attached to the body (6) and which is for preventing rotation of the body (6) during rotation of the spindle (16) for removing the compression ring (4) from the pipe (24), and during rotation of the compression ring nut (10) for installing the compression ring (4) on the pipe (24).

This application claims priority to and the benefit of United Kingdom Patent Application No. 0624569.0 filed on Dec. 8, 2006 which is hereby incorporated herein by reference.

This invention relates to apparatus for removing or fitting a compression ring.

Compression rings are widely used as a means of joining tubular members such as pipes. The compression rings usually form part of compression fittings. Whilst carrying out routine maintenance, repairs and alterations to pipe systems, it is often necessary to have to remove compression fittings with compression rings. This may be so that a new fitting can be installed, or so that a new joint or termination can be made. During removal of a compression rings, it is important that no damage is caused to the tubular member such for example as the pipe. Similarly, during fitting of a new compression ring, it is important that no damage is caused to the tubular member and/or joints in a system due to leverage being applied during the fitting process.

Tools for the removal of compression rings are known. Typically a known tool takes the form of a cutting device comprising cutting blades used to remove the compression rings. These cutting blades can distort and/or score a pipe containing the compression ring. The known tools also cannot be used for the fitment of compression rings. Still further, the known tools cannot stop damage caused by leverage to a pipe or a system which the pipe is installed.

One known type of apparatus for removing a compression ring is disclosed in GB-A-2384456. This apparatus comprises a body, an externally threaded portion which is on the body and which is for receiving a compression ring, a bore which is in the body and which has a screw thread, a spindle which is externally threaded and which is screwable backwards and forwards in the bore in the body, and abutment means for engaging an end of a pipe requiring the compression ring to be removed. The body is provided with a six-sided nut formation so that the body is able to receive a spanner for enabling the apparatus to be held tight whilst the compression ring nut is tightened. The apparatus is often required to be used in confined situations where there is little space. For example pipes are typically installed at ground level and in cupboards. Pipes in boilers are especially difficult to access because the boilers usually contain a great deal of equipment in a confined space. It often happens that it is very difficult to get a spanner on the six-sided nut formation on the body of the known apparatus. The result is often that unwanted leverage is applied to a pipe or a component in a pipe system, possibly resulting in leaks to existing joints in the pipe system.

It is an aim of the present invention to obviate or reduce the above mentioned problem.

Accordingly, in one non-limiting embodiment of the present invention there is provided apparatus for removing or fitting a compression ring, which apparatus comprises a body, at least one externally threaded portion which is on the body and which is for receiving a compression ring nut, a bore which is in the body and which has a screw thread, a spindle which has an external thread and which is screwable backwards and forwards in the bore in the body, at least one abutment means for engaging an end of a pipe requiring the compression ring to be removed, and a handle which in use is permanently attached to the body and which is for preventing movement of the body during rotation of the spindle for removing the compression ring from the pipe, and during rotation of the compression ring nut for installing the compression ring on the pipe.

With the apparatus of the present invention, the handle ensures that it is always possible to hold the apparatus in position, and thereby avoid unwanted movement of the apparatus and consequent unwanted movement of a part or parts of a pipe system. The handle obviates the need to fit a spanner on the body in order to hold the body still. The handle also provides a manufacturing advantage insofar as it is not necessary to form the body with the six sided nut portion.

Usually, the apparatus will be one in which the handle extends at right angles to the body.

The handle may be formed as an integral part of the body. Alternatively, the handle may be separately formed from the body and then connected to the body. In this case, the handle may be connected to the body by a screw connection. For example, the handle may have a screw threaded projection which screws into a screw threaded bore in the body. Alternatively, the handle may have a screw threaded recess which receives a screw threaded projection on the body. Alternatively the handle may be welded to the body. If the handle is separately formed from the body, then it can be connected to the body by any suitable and appropriate means.

The apparatus may be one in which there are two of the externally threaded portions, one of the externally threaded portions being for use with a compression ring of a first size, and the other of the externally threaded portions being for use with a compression ring of a second and different size. The compression ring of the first size may be a 15 mm compression ring, and the compression ring of the second size may be a 22 mm compression ring.

The apparatus may be one in which there are two of the abutment means, and in which the abutment means are separately formed from the spindle. In use, the spindle will then be screwed through the externally threaded portion that is appropriate to the size of the compression ring being fitted.

The two abutment means may be releasably connectable to the handle for storage purposes when they are not in use. This ensures that the abutment means do not get misplaced, and that they are always ready with the apparatus for use. Preferably, the two abutment means are releasably connectable to the handle by each abutment means being a screw threaded fit into its own screw threaded aperture in the handle. The screw threaded aperture may be in the form of a through bore, or it may be a blind bore.

The apparatus of the present invention may be one in which the handle includes at least one open mouthed slot for enabling the handle to fit over the pipe, and the apparatus to be struck to knock the compression ring off the pipe if this should be necessary. There may be two of the open mouthed slots, one of the open mouthed slots being for use with a compression ring of a first size, and the other of the open mouthed slots being for use with a compression ring of a second and different size.

The apparatus of the present invention will usually be sold without the compression ring. Compression rings will usually be purchased in bulk by plumbers and fitters. If desired however, the apparatus of the present invention may be manufactured and sold with one or more of the compression rings.

Embodiments of the invention will now be described solely by way of example and with reference to the accompanying drawings in which:

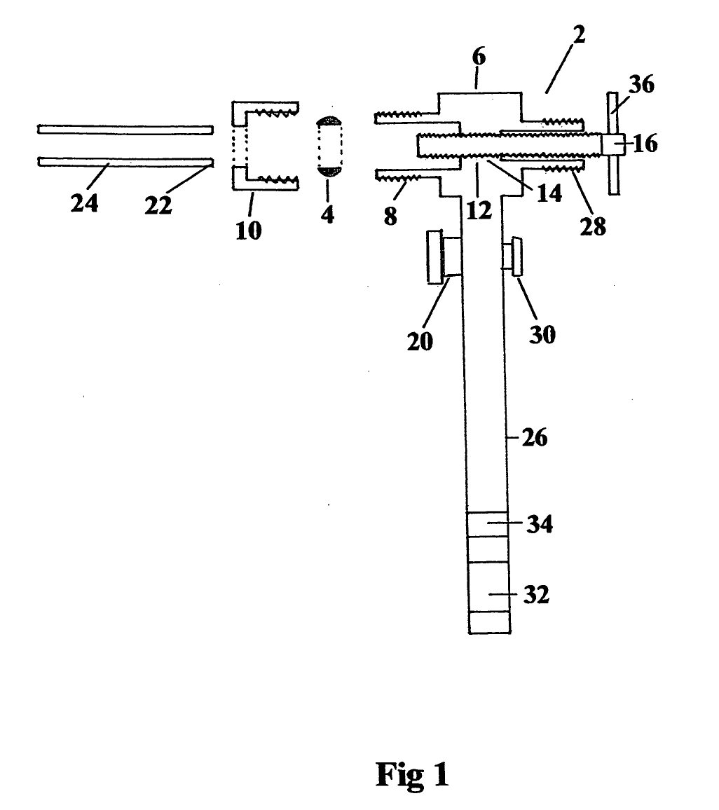

FIG. 1 is a side sectional view of first apparatus of the present invention;

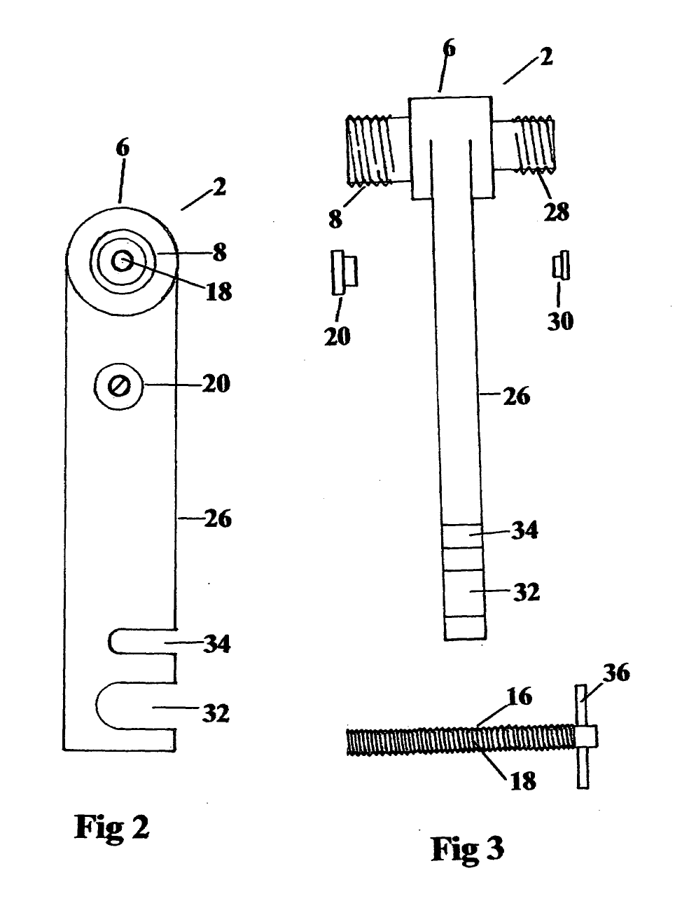

FIG. 2 is an end view of the apparatus as shown in FIG. 1;

FIG. 3 is a side view like FIG. 1 but in exploded form;

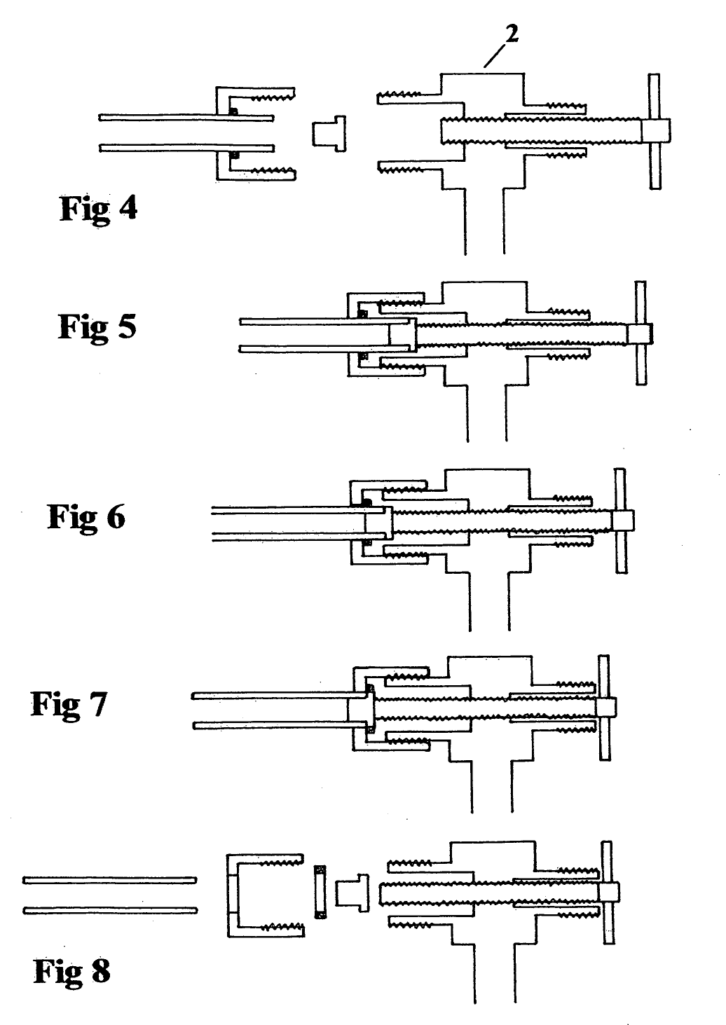

FIGS. 4-8 show different steps during the use of the apparatus shown in FIGS. 1-3 in removing a compression ring from a pipe;

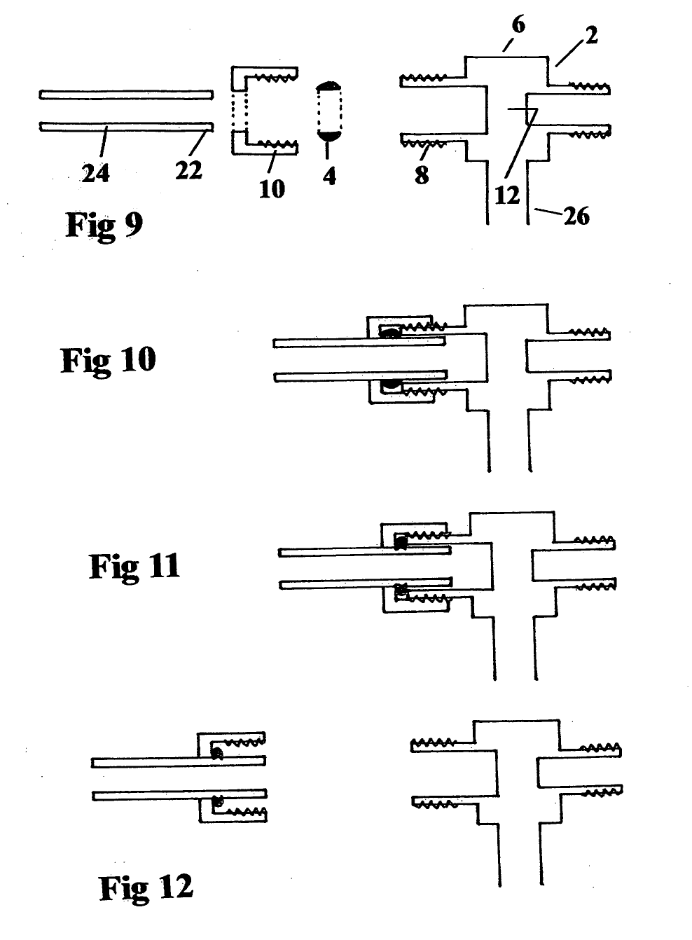

FIGS. 9-12 show the apparatus of FIGS. 1-3 being used to fit a compression ring on a pipe;

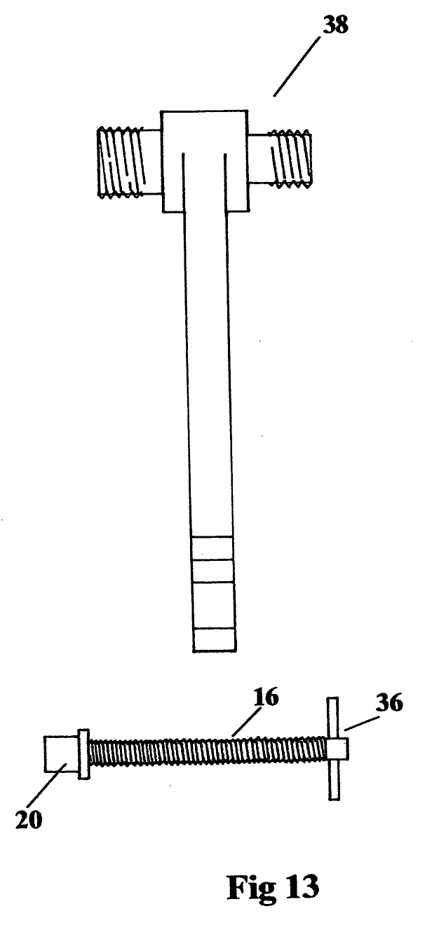

FIG. 13 is a view like FIG. 3 but shows second apparatus of the present invention; and

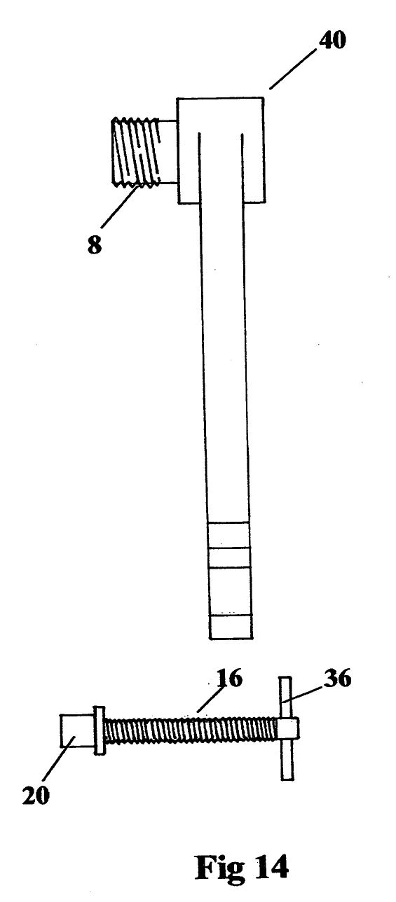

FIG. 14 is a view like FIG. 3 but shows third apparatus of the present invention.

Referring to FIGS. 1-3, there is shown apparatus 2 for removing or fitting a compression ring 4. The apparatus 2 comprises a body 6. The body 6 has an externally threaded portion 8 which is on the body 6 and which is for receiving a compression ring nut 10.

The apparatus 2 also comprises a bore 12 which is in the body and which has a screw thread 14. A spindle 16 has an external thread 18. The spindle 16 is screwable backwards and forwards in the bore 12 in the body 6.

The apparatus 2 further comprises abutment means 20 for engaging an end 22 of a pipe 24 requiring the compression ring 4 to be removed.

The apparatus 2 further comprises a handle 26 which in use is permanently attached to the body 6. The handle 26 is for preventing movement of the body 6 during use of the apparatus 2. More specifically, the handle 26 is for preventing rotation or other movement of the body 6 during rotation of the spindle 16 for removing the compression ring 4 from the pipe 24. The handle 26 is also for preventing rotation or other movement of the body during rotation of the compression ring nut 10 for installing the compression ring 4 on the pipe 24.

As can be appreciated from FIGS. 1, 2 and 3, the handle 26 extends at right angles to the body 6. The handle 26 is formed as an integral part of the body 6. In an alternative embodiment of the invention (not shown), the handle 26 may be separately formed from the body 6, and then connected to the body 6, for example by a screw connection.

As can be seen from FIGS. 1 and 3, the externally threaded portion 8 is one of two externally threaded portions. The other externally threaded portion is an externally threaded portion 28. The externally threaded portion 8 is for use with a compression ring of a first size. The externally threaded portion 28 is for use with a compression ring of a second and smaller size.

As can also be seen from FIGS. 1 and 3, the abutment means 20 is one of two abutment means. The other abutment means is an abutment means 30. The two abutment means 20, 30 are separately formed on the spindle 16. Whichever one of the abutment means 20, 30 is desired to be used, is screwed onto the free end of the spindle 16. In use of the apparatus 2 as shown in FIG. 1, the abutment means 20 would be required to be fitted to the end of the spindle 16, the abutment means 20 being larger than the abutment means 30, and the abutment means 20 being appropriate for extending from the externally threaded portion 8 which is larger than the externally threaded portion 28.

As can be appreciated from FIG. 3, the two abutment means 20, 30 are releasably connectable to the handle 26 for storage purposes when they are not in use. The two abutment means 20, 30 are releasably connectable to the handle 26. More specifically, each abutment means 20, 30 is a screw threaded fit into its own screw threaded aperture in the handle 26. Each one of the screw threaded apertures in the handle may be in the form of a through bore or a blind bore.

The handle 26 includes an open mouthed slot 32 for enabling the handle 26 to fit over the pipe 24, and the apparatus 2 then to be struck from one side to knock the compression ring 4 off the pipe 24. As can be seen from FIGS. 1, 2 and 3, the open mouthed slot 32 is one of two open mouthed slots. The other open mouthed slot is an open mouthed slot 34. The open mouthed slot 34 is smaller than the open mouthed slot 32. Thus the open mouthed slot 34 is for use with a compression ring of a second and smaller size than the compression ring 4, and on a pipe of a smaller diameter than the pipe 24.

The spindle 16 has a bar 36 for enabling the spindle 16 to be screwed backwards and forwards in the bore 12 of the body 6.

FIGS. 4-8 show the various steps employed in using the apparatus 2 to remove the compression ring 4 from the end 22 of the pipe 24. As can be seen from FIG. 4, the apparatus 2 is first assembled and then connected to the end 22 of the pipe 24 as shown in FIG. 5. Screwing of the spindle 16 through the bore 12 in the body 6 causes the apparatus 2 to slide away from the end 22 of the pipe 24 as can be seen from a comparison of FIGS. 5, 6 and 7. Eventually the compression ring 4 falls off the end 22 of the pipe 24, and the apparatus 2 will then be separate from the pipe 24 as can be appreciated from FIG. 8. As can also be appreciated from FIG. 8, the compression ring nut 10 can then be unscrewed from the externally threaded portion 8, in order to retrieve the old removed compression ring 4.

Referring now to FIGS. 9-12, there are shown the various steps employed in using the apparatus 2 to fit a new compression ring 4. In FIGS. 9 and 12, it will be seen that the fitting of a new compression ring 12 does not require the use of the spindle 16. In order to fit the new compression ring 4, it is simply necessary to assemble the apparatus 2 as shown in FIG. 9, and then to tighten the compression ring nut 10 on the externally threaded portion 8 as shown in FIG. 10. Further tightening of the compression ring nut 10 on the externally threaded portion 8 causes the compression ring 4 to bite into the outer surface of the pipe 24 as can be appreciated from FIG. 11. The compression ring nut 10 can be unscrewed from the externally threaded portion 8 as can be appreciated from FIG. 12. The pipe 2 with the compression ring nut 10 and the new compression ring 4 is then ready for forming part of a pipe fitting enabling the end 22 of the pipe 24 to be connected to an end of another pipe (not shown).

During the use of the apparatus 2 in removing the old compression ring 4 as shown in FIGS. 4-8, and also during use of the apparatus 2 in fitting a new compression ring 4 as shown in FIGS. 9 and 12, the presence of the handle 26 is advantageous in that the body 6 is easily able to be held firm and steady by using the handle 26. This facilitates the avoidance of placing unwanted strains on a pipe system including the pipe 24, and thereby helps to avoid unwanted leaks that might occur as a result of the strains being placed on the system. Still further, by being able to hold the body 6 steady, the handle 26 ensures that the old compression ring 4 is able to be removed from the end 22 of the pipe 24 with minimum damage to the pipe 24. Thus the pipe 24 is more likely to be able to accept the new compression ring 4 in a simple manner and without leaks than would be the case if the pipe 24 were subjected to unwanted strains and possibly become damaged.

Referring now to FIG. 13, there is shown apparatus 38 which is like the apparatus 2. Similar parts have been given the same reference numerals for ease of comparison and understanding. In the apparatus 34, the abutment means 20 is formed as a permanent fixture to the end of the spindle 16 opposite the bar 36.

Referring now to FIG. 14, there is shown apparatus 40 which is like the apparatus 38 shown in FIG. 13. Again similar parts have been given the same reference numerals for ease of comparison and understanding. In the apparatus 40, there is only the externally threaded portion 8. The externally threaded portion 28 has been dispensed with because the abutment means 20 is fixed to the spindle 16 and therefore the spindle 16 cannot be removed from the body 6. Thus with the apparatus 40, everything will be fixed in position and the apparatus 40 will be for use with one size of compression ring 4 only.

It is to be appreciated that the embodiments of the invention described above with reference to the accompanying drawings have been given by way of example only and that modifications may be effected. Thus, for example, the bar 36 may be replaced by a flat-sided formation for receiving a spanner in order to rotate the spindle 16. The body portion 6 and the handle 26 may be of shapes other than those shown. The handle 26 may be manufactured without the open mouthed slots 32, 34. The apparatus of the invention may be made of any suitable and appropriate metal. The pipe can be a long pipe, for example for cold water, hot water, or gas. Alternatively, the pipe can be a short pipe, for example a stub pipe on a pump or on a compressor.

1. Apparatus for removing or fitting a compression ring, which apparatus comprises a body, at least one externally threaded portion which is on the body and which is for receiving a compression ring nut, a bore which is in the body and which has a screw thread, a spindle which has an external thread and which is screwable backwards and forwards in the bore in the body, at least one abutment means for engaging an end of a pipe requiring the compression ring to be removed, and a handle which in use is permanently attached to the body and which is for preventing movement of the body during rotation of the spindle for removing the compression ring from the pipe, and during rotation of the compression ring nut for installing the compression ring on the pipe.

2. Apparatus according to claim 1 in which the handle extends at right angles to the body.

3. Apparatus according to claim 1 in which the handle is formed as an integral part of the body.

4. Apparatus according to claim 1 in which the handle is separately formed from the body and is then connected to the body.

5. Apparatus according to claim 1 in which there are two of the externally threaded portions, one of the externally threaded portions being for use with a compression ring of a first size, and the other of the externally threaded portions being for use with a compression ring of a second and different size.

6. Apparatus according to claim 5 in which there are two of the abutment means, and in which the abutment means are separately formed from the spindle.

7. Apparatus according to claim 6 in which the two abutment means are releasably connectable to the handle for storage purposes when they are not in use.

8. Apparatus according to claim 7 in which the two abutment means are releasably connectable to the handle by each abutment means being a screw threaded fit into its own screw threaded aperture in the handle.

9. Apparatus according to claim 1 in which the handle includes at least one open mouthed slot for enabling the handle to fit over the pipe, and the apparatus to be struck to knock the compression ring off the pipe.

10. Apparatus according to claim 9 in which there are two of the open mouthed slots, one of the open mouthed slots being for use with a compression ring of a first size, and the other of the open mouthed slots being for use with a compression ring of a second and different size.

11. Apparatus according to claim 1 and including the compression ring.
